(19) United States
(12) Patent Application Publication
(10) Pub. No.: US 2012/0148947 A1
(43) Pub. Date: Jun. 14, 2012

(54) DEVELOPER, DEVELOPER CONTAINER, IMAGE FORMING UNIT AND IMAGE FORMING APPARATUS

(75) Inventor: Yuki MATSUURA, Tokyo (JP)

(73) Assignee: OKI DATA CORPORATION, Tokyo (JP)

(21) Appl. No.: 13/313,617

(22) Filed: Dec. 7, 2011

(30) Foreign Application Priority Data
Dec. 10, 2010 (JP) 2010-275787

(51) Int. Cl. G03G 9/00; G03G 15/08

(52) U.S. Cl. 430/105; 430/109.1; 430/109.4; 399/252

(57) ABSTRACT

Disclosed is a developer including at least a toner for developing electrostatic latent images. The toner includes toner base particles each containing at least one binder resin, and external additives for adhering to the outer surfaces of the toner base particles. The toner has a first triboelectric charge obtained by blow-off charge measurement at 20% relative humidity and a temperature of 10° C., and a second triboelectric charge obtained by blow-off charge measurement at 80% relative humidity and a temperature of 28° C. An absolute value of the difference between the first and second triboelectric charges is no larger than 20 μC/g.

### BACKGROUND OF THE INVENTION

1. Field of the Invention

The present invention relates to techniques for forming an image on a recording medium by an electrophotographic process.

An electrophotographic image forming process includes the following consecutive steps: charging a photoconductor to form a uniformly charged surface of the photoconductor; exposing the photoconductor to light to form an electrostatic latent image on the charged surface of the photoconductor; developing the electrostatic latent image by adhering a charged developer to the electrostatic latent image, to form a developer image on the photoconductor; transferring the developer image onto a recording medium such as a piece of paper; and fixing the transferred developer image to the recording medium. A typical developer is composed of a mixture of toner base particles each containing at least one binder resin, one colorant, and external additives for adhering the outer surfaces of the toner base particles. The external additives are fine particles that can be added to modify the surface of the toner base particles for the purposes of, for example, improvement of fluidity of the developer, preventing of fusion of the binder resin, and/or improvement of developer charging characteristics.

2. Description of the Related Art

A related art concerning an electrophotographic developer is disclosed in, for example, Japanese Patent Application Publication No. H11 (1999)-242352. Japanese Patent Application Publication No. H11 (1999)-242352 discloses an image forming apparatus that can improve developer charging characteristics by using a toner whose absolute value of triboelectric charges measured by blow-off charge measurement is 60 μC/g or more.

The characteristics of the conventional developer, however, is possibly unstable in the developer charge and fluidity due to change of ambient environment in image formation. This can allow formation of a false image in the background part of a normal image by developer adhesion to the background part, thus causing degradation of its image quality.

### SUMMARY OF THE INVENTION

In view of the foregoing, it is an object of the present invention to provide a developer, a developer container, an image forming unit and an image forming apparatus which improve image quality.

According to a first aspect of the invention, there is provided a developer including at least a toner for developing electrostatic latent images. The toner includes toner base particles each containing at least one binder resin; and external additives for adhering to outer surfaces of the toner base particles. The toner has a first triboelectric charge obtained by blow-off charge measurement at 20% relative humidity and a temperature of 10° C., and a second triboelectric charge obtained by blow-off Charge measurement at 80% relative humidity and a temperature of 28° C. An absolute value of a difference between the first and second triboelectric charges being no larger than 20 μC/g.

According to a second aspect of the invention, there is provided a developer container that contains the toner.

According to a third aspect of the invention, there is provided an image forming unit which includes: the developer container; an image carrying member on which an electrostatic latent image is formed; and a developer carrying member, having the developer provided by the developer container thereon, for bringing the developer into the electrostatic latent image thereby to form a developer image.

According to a fourth aspect of the invention, there is provided an image forming apparatus which includes the image forming unit.

According to the aspects of the invention, improvement of the image quality can be achieved.

### BRIEF DESCRIPTION OF THE DRAWINGS

In the attached drawings:

FIG. 1 is a schematic diagram illustrating a main structure of an electrophotographic image forming apparatus of an embodiment;

FIG. 2 schematically illustrates a structure of an image forming unit (developing unit) that is implemented in the image forming apparatus;

FIG. 3 is a schematic diagram of a shaker for explaining a blow-off charge measurement condition;

FIG. 4 illustrates a table in which measurement results and corresponding evaluations are listed with respect to various pulverized toners; and

FIG. 5 illustrates a table in which measurement results and corresponding evaluations are listed with respect to various polymerized toners.

### DETAILED DESCRIPTION OF THE INVENTION

Embodiments of the invention will now be described with reference to the attached drawings, in which like elements are indicated by like reference characters.

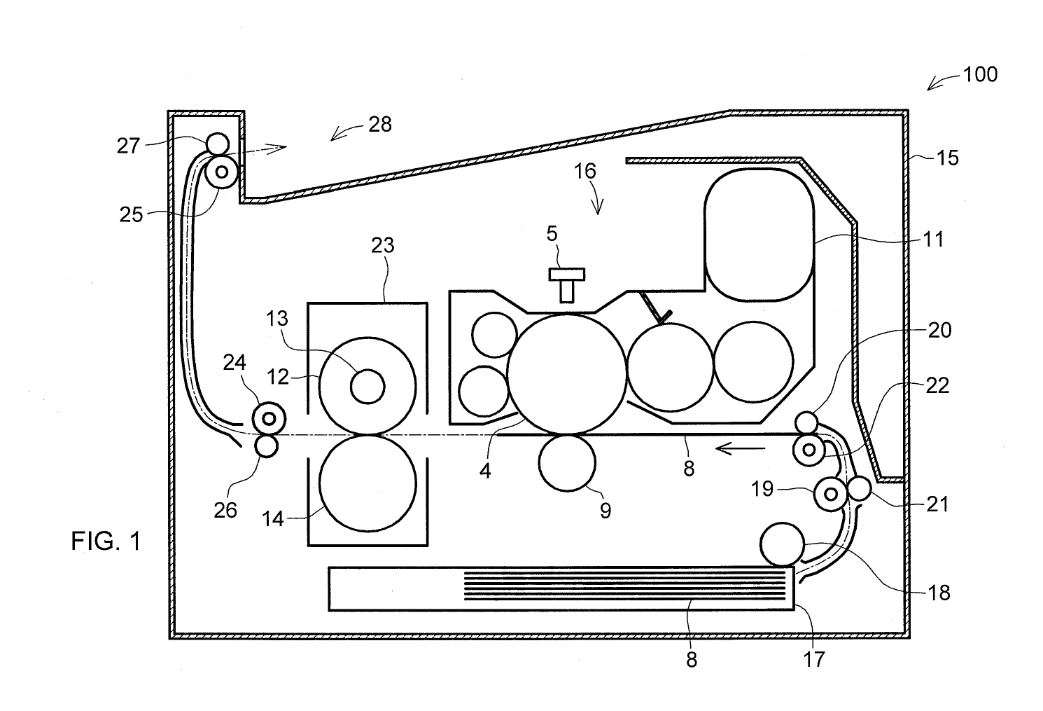

FIG. 1 is a schematic diagram illustrating a main structure of an electrophotographic image forming apparatus 100 of the present embodiment. As illustrated in FIG. 1, the image forming apparatus 100 has a chassis 15. The image forming apparatus 100 further includes, in the chassis 15, a cassette 17 for housing recording mediums 8 to which developer images are to be transferred; a carrying mechanism for carrying the recording mediums 8; an image forming unit (i.e., a developing unit) 16; a transfer roller 9 for transferring developer images onto the recording mediums 8; and a fixing unit 23 for fixing the developer images on the recording mediums 8. The carrying mechanism has a hopping roller 18, pinch rollers 19 and 20, a resist roller 22, and a carrying roller 21 which are used to carry the recording medium 8 into the image forming unit 16. The carrying mechanism further has eject rollers 24 and 25, and pinch rollers 26 and 27. These rollers 24 to 27 are used to carry the recording medium 8 from the fixing unit 23 to an output part 28.

The cassette 17 detachably mounted to the image forming apparatus 100 has a function to accommodate a stack of the recording mediums 8. Examples of the recording medium 8 are sheet-like objects such as paper, plastic films, synthetic paper and cloth.

The hopping roller 18 is disposed on an upper side of the cassette 17 near an output part to which the recording medium is to be fed. The hopping roller 18 feeds the recording mediums 8 one by one from the cassette 17 to a space between the pinch roller 19 and the carrying roller 21 on the downstream side of a feed path. The pinch roller 19 and the carrying roller 21, while pressing the both sides of the recording medium 8, feed the recording medium 8 from the cassette 17 to a space between the pinch roller 20 and the resist roller 22 on the downstream side of the feed path. The pinch roller 20 and the resist roller 22j, while pressing the both sides of the recording medium 8 to correct the oblique direction of movement, feed the recording medium 8 to a space between the image forming unit 16 and a transfer roller 9. The hopping roller 18, the carrying roller 21 and the resist roller 22 can feed the recording medium 8 by rotating in response to a power from a drive source (not illustrated) through a power transmission mechanism such as a gear.

At a position opposite to the photosensitive drum 4 in the image forming unit 16, the transfer roller 9 made of conductive rubber or the like is disposed. The transfer roller 9 is a member that transfers (moves) a developer image on the photosensitive drum 4 to the recording medium 8. For example, the transfer roller 9 can be disposed so as to supply a pressure to the surface of the photosensitive drum 4 through a transfer belt (not illustrated). A high-voltage power supply (not illustrated in the drawing) applies, to the transfer roller 9, a voltage to provide a difference in electrical potential between the surface of the photosensitive drum 4 and the surface of the transfer roller 9 when the developer image is transferred.

The fixing unit 23 has a function to fuse and fix the toner image to the recording medium 8 by applying pressure and heat to the transferred developer image on the recording medium 8. The fixing unit 23 has a heat roller 12 and a backup roller 14 which have circular tube shapes. The heat roller 12 can be formed by coating a surface of an aluminum base tube with a fluorocarbon polymer, such as PFA (Perfluoro alkoxyl alkane) and/or PTFE (Polytetra fluoro ethylene). A heat source 13 such as a halogen lamp is disposed inside the heat roller 12. A power source (not illustrated) exists to apply a bias voltage to the heat source 13. The backup roller 14 has a surface layer made of elastic body material.

The eject roller 24 and the pinch roller 26, while pressing the both sides of the recording medium 8, feed the recording medium 8 fed from the fixing unit 23 to a space between the eject roller 25 and the pinch roller 27. The eject roller 25 and the pinch roller 27, while pressing the both sides of the recording medium 8, feed the recording medium 8 to the output part 28 which is capable of folding and accommodating the recording mediums 8 on which images are formed. The backup roller 14 and the eject rollers 24 and 25 can feed the recording medium 8 by rotating in response to a power from a drive source (not illustrated) through a power transmission mechanism such as a gear.

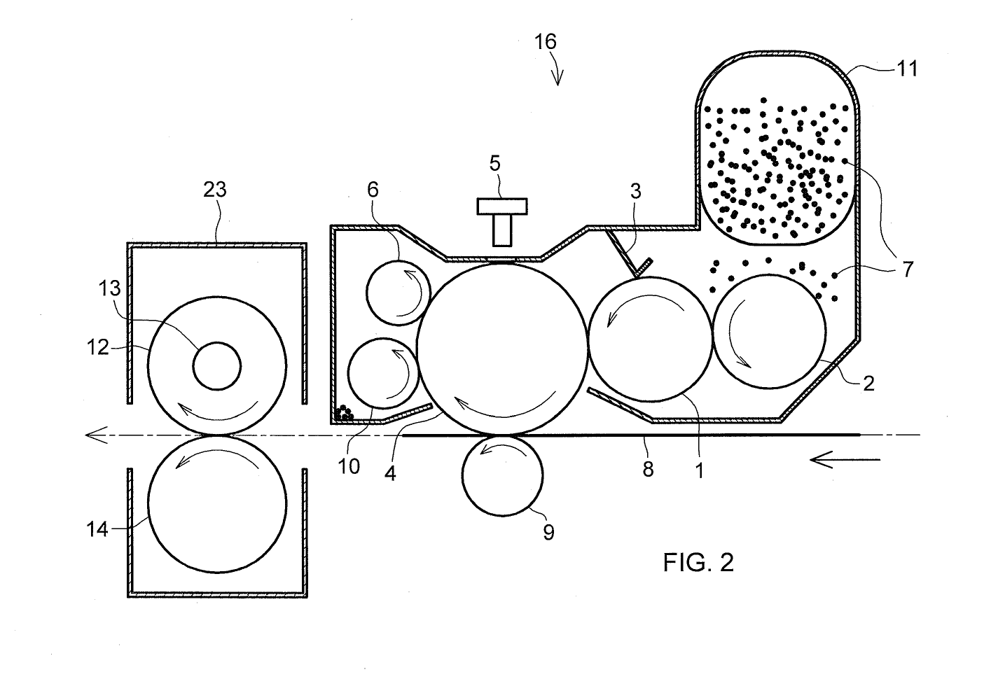

FIG. 2 schematically illustrates a structure of the image forming unit 16 implemented in the image forming apparatus 100. The image forming unit 16 carries out a single-component development. The image forming unit 16 has a developer cartridge (developer container) 11 that contains a developer 7. In this embodiment, a non-magnetic single-component developer (hereinafter referred to as the “toner”) can be used as the developer 7. As will be described below, the toner is comprised of fine particles that include toner base particles and external additives. The toner base particles are negatively charged, and each of the toner base particle contains at least one binder resin and one colorant. The external additives adhere to outer surfaces of the toner base particles to modify the outer surfaces. The particle diameter of each of the external additives is smaller than that of the toner base particle. Alternatively, a dual component developer (or a two-component developer) containing both a carrier and the toner can be used as the developer 7. The carrier can be comprised of carrier core particles and at least one polymer coated over the carrier core particles. The carrier core particles can include ferrites, iron ferrites, nickel, silicon dioxide, steel, and/or the like.

The developer 7 used in the embodiment has a first triboelectric charge obtained by blow-off charge measurement at 20% relative humidity and a temperature of 10° C. (i.e., a low temperature and low humidity environment), and a second triboelectric charge obtained by blow-off charge measurement at 80% relative humidity and a temperature of 28° C. (i.e., a high temperature and high humidity environment). The developer 7 further has a first toner cohesion value measured under the high temperature and high humidity environment, and a second toner cohesion value measured under the low temperature and low humidity environment. The absolute value of a difference Δq between the first and second triboelectric charges is no larger than 20 μC/g, and the first toner cohesion value is in the range of 30 to 70 percent. This enables suppression of the occurrence of so-called “fog.” Fog means developer adhesion to a background part of the image formed on a recording medium, forming a false image in the background part. Fog can occur due to insufficient electrical charge of a developer, or due to static electricity of a developer of opposite polarity. Furthermore, it is preferable that the second toner cohesion value be in the range of 10 to 50 percent. This enables suppression of the occurrences of both fog and so-called “smudge.” In the embodiment, smudge means toner adhesion to the background part due to overcharging of a toner.

A flowability index of a toner is defined as follows:

Fi=100−Cv,

where Fi denotes the flowability index (unit: %), and Cv denotes a toner cohesion value. The first flowability index is obtained under the low temperature and low humidity environment, and the second flowability index is obtained under the high temperature and high humidity environment. In this case, the developer 7 has the difference Δq which is no larger than 20 μC/g, and the second flowability index which is in the range of 30 to 70 percent. In other words, it is preferable that the first flowability index be in the range of 50 to 90 percent. Hereinafter, the high temperature and high humidity environment is referred to as ‘HH environment’ and the low temperature and low humidity environment is referred to as ‘LL environment’.

As illustrated in FIG. 2, the image forming unit 16 includes a photoconductor drum 4 which is an image carrying member on which an electrostatic latent image is to be formed; a charging roller 6 for supplying electrical charge to the photoconductor drum 4; an LED head (exposing unit) 5 for exposing to light to form an electrostatic latent image on the surface of the photoconductor drum 4; a development roller 1 which is a developer carrier; a sponge roller 2 which is a developer supplying member; a developing blade 3 which is a means of forming a developer layer; and a cleaning roller 10 for scraping the remaining developer 7 that remains on the photoconductor drum 4 without being transferred. The developer cartridge 11 supplies the developer 7. The charging roller 6, the development roller 1, the transfer roller 9 and the cleaning roller 10 are in contact with the surface of the photoconductor drum 4. The sponge roller 2 is in contact with the surface of the development roller 1.

For example, the photoconductor drum 4 can include a metal tube of aluminum or the like (conductive base), and a photoconductive layer of organic photoconductor (OPC) or the like formed around the metal tube. The photoconductive layer has a laminated structure that includes a charge generation layer and a charge transport layer. The LED head 5 includes an LED device (light emitting diode device), an LED driving unit for driving the LED device, and a lens array for guiding light emitted from the LED device to the surface of the photoconductor drum 4.

The development roller 1 adheres the developer 7 to an electrostatic latent image on the photoconductor drum 4 by contact development. Namely, the development roller 1 adheres the developer 7 to the electrostatic latent image on the photoconductor drum 4 by contact with the surface of the photoconductor drum 4. The development roller 1 is manufactured, for example, by forming on a conductive shaft an elastic body layer made of semiconductor silicon rubber to which UV light is applied, and then coating a surface of the elastic body layer to form a coating layer and a silane coupling agent layer of polyurethane resin. The coating layer includes silica particles to have surface roughness. A thickness of the coating layer can be in the range of 7 μm to 13 μm, for example. It is preferable to polish the coated surface of the development roller 1 so as to have the surface roughness Rz in the range of 3 μm to 12 μm in accordance with JIS (Japanese Industrial Standards) B 0601-1994, if necessary. It is desirable that a value of Rz should be large as much as possible in order to ensure a print density. A value of electrical resistance R of the development roller 1 is given by R=Vd/I, where Vd denotes a voltage applied between the surface of the development roller 1 and the conductive shaft while contact is made by a force of 20 gf between the surface of the development roller 1 and an SUS ball bearing having a width of 2.0 mm and a diameter of 6.0 mm; and I is a current between the surface of the development roller 1 and the conductive shaft. When the voltage Vd is 100V, it is possible to obtain the roller resistance R of 100 MΩ to 5000 MΩ.

The sponge roller 2 is manufactured by forming semiconductive silicone foam rubber on the conductive shaft and polishing so as to have a predetermined outer diameter. The silicone rubber compound is made by adding reinforcing silica fillers, a vulcanizing agent for vulcanization and a foaming agent, to raw rubber such as dimethyl silicone raw rubber and methyl phenyl silicone raw rubber. As the foaming agent, an inorganic foaming agent such as sodium bicarbonate, or an organic foaming agent such as ADCA (amide azodicarboxylate or azodicarbonamide) can be used. A hardness of the roller can be 48±5° measured by using Asker F. In the image forming unit 16, the sponge roller 2 can be pressed about 1.0±0.15 mm into the development roller 1. The sponge roller 2 has a roller resistance in the range of 1MΩ to 100 MΩ measured like that of the development roller 1, when 300 V is applied.

The cleaning roller 10 has a conductive foam layer that is adhered to an external circumference of a metal cored bar of φ6 with a primer. The conductive foam layer can be mainly composed of EPDM (ethylene-propylene-diene rubber). An average foamed cell diameter of the conductive foam layer can be in the range from 100 μm to 300 μm. The foamed cell diameter can be measured by using a stereoscopic microscope. A rubber hardness of the conductive foam layer can be in the range from 35° to 45°. The rubber hardness can be measured by using a durometer (Asker Durometer type C) under a load of 4.9 Newton. On application of a positive voltage or a negative voltage from a predetermined power supply for a cleaning device, the cleaning roller 10 collects a part of the toner which remains on the photosensitive drum 4 without being transferred. Moreover, the cleaning roller 10 is pressure-welded to the surface of the photosensitive drum 4 by a spring elastic force provided to both ends of a shaft of the cleaning roller 10. With respect to an actually manufactured cleaning roller 10, a roller resistance was measured to be in the range from 2.0×10⁶Ω to 2.0×10⁷Ω when the cleaning roller 10 was rotated while being pressed about 0.25 mm into the photosensitive drum 4 of φ30 (in whole surface resistance) and 400 V was applied.

The charging roller 6 has a conductive, elastic layer. The conductive elastic layer is an ion-conductive elastic rubber layer which is mainly composed of epichlorohydrin rubber (ECO). A surface treatment is applied to a surface of the elastic layer. In the surface treatment, the surface hardens by permeation of a surface treatment liquid including isocyanate (HDI) component. Thereby, it is possible to reduce uncleanliness of the photosensitive drum 4 and to easily remove the developer 7, the external additives and the like. A hardness of the elastic layer of the charging roller, 6 can be measured by using a durometer Asker C (manufactured by Kobunshi Keiki Co., Ltd.). By measuring an actually manufactured charging roller 6, a hardness was 73 degrees and a roller resistance value was 6.3 (=log Ω). The roller resistance value was measured at 50% RH (Relative Humidity) and a temperature of 20° C. by using a conductive metal drum which has the same outer diameter and roughness as the photosensitive drum 4 to be actually used, and the measurement was made when the charging roller 6 and the conductive metal drum were nipped by the same pressure as that on the photosensitive drum 4 and a DC voltage 500 V was applied.

Next, the operation of the image forming apparatus 100 having the structure described above will be explained below.

First, an instruction indicating image formation is input to a control unit (not illustrated) that controls the whole operation of the image forming apparatus 100. In response to the instruction, a motor of a main section of the image forming apparatus 100 (not illustrated) starts rotating, and a driving power is transmitted to a drum gear through some gears in the main section. Thus, the photosensitive drum 4 rotates. A driving power transmission to a developing gear from the drum gear causes the developing roller 1 to rotate. A driving power transmission to a sponge gear from the developing gear through an idle gear causes the sponge roller 2 to rotate. Moreover, a driving power transmission to a charge gear from the drum gear causes the charging roller 6 to rotate, a driving power transmission to a cleaning gear from the drum gear causes the cleaning roller 10 to rotate, and a driving power transmission to a transfer gear from the drum gear causes the transfer roller 9 to rotate. Furthermore, a rotation driving power of the motor in the main section is transmitted to a heat roller gear through some gears for another system in the main section. Thus, the heat roller 12 rotates. The backup roller 14 rotates in response to the rotation of the heat roller 12. FIG. 2 illustrates how the rollers and the photosensitive drum 4 rotate.

At substantially the same time as a start of the rotation of the motor, a power source in the main section applies predetermined bias voltages to the rollers used in a developing process and a transferring process, and to the halogen lamp 13 used in a fixing process.

The charging roller 6 to which a voltage is applied rotates. Thus, a surface layer of the photosensitive drum 4 is uniformly charged (e.g., the surface layer is charged to a potential of −600V). When a charged part of the photosensitive drum 4 reaches under the LED head 5, the LED head 5 emits light according to image data supplied to a control unit (not illustrated) to form an electrostatic latent image on the photosensitive drum 4.

For example, a voltage of −300V can be applied to the sponge roller (supply roller) 2, and a voltage of −200V can be applied to the development roller 1. The developer is charged by friction of the sponge roller (supply roller) 2 and the development roller 1. When the electrostatic latent image formed on the photosensitive drum 4 reaches the development roller 1, a thin film of the developer 7 made by the developing blade 3 transfers onto the photosensitive drum 4 by a potential difference between the development roller 1 and the electrostatic latent image (which has a potential of −20V, for example) formed on the photosensitive drum 4.

In the transferring process, the developer 7 transferred on the recording medium 8 is fixed on the recording medium 8 by heat of the heat roller 12 that is warmed by the halogen lamp 13, and by pressure between the heat roller 12 and the backup roller 14. The remaining part of the developer 7 which remains on the photosensitive drum 4 is scraped by the cleaning roller 10 and collected in accordance with a sequence determined by a control unit (not illustrated) after image forming is finished.

Next, the developer 7 used in the embodiment will be explained. The developer 7 can be produced by a mechanical grinding (pulverization) method or an emulsion polymerization method. According to the mechanical grinding method, toner base particles are produced by melting and mixing toner material which is mainly composed of a binder resin and a colorant, and then, cooling, grinding and classifying it. Subsequently, the developer (i.e., pulverized toner) 7 is produced by adding external additives to the toner base particles. On the other hand, according to the emulsion polymerization method, toner base particles are produced by polymerizing a polymerizable monomer containing a precursor of a binder resin and a polymerizable monomer composition which is mainly composed of a colorant in an emulsifier containing a cross-linking agent, a polymerization initiator and the like, and then associating them. Subsequently, the developer (i.e., polymerized toner) 7 is produced by adding external additives to the toner base particles.

An example of the binder resin used for the developer 7 is a thermoplastic resin, such as a vinyl resin, a polyamide resin or a polyester resin. Examples of a monomer to form the vinyl resin which is one of the thermoplastic resins are as follows: styrene or styrene derivatives, such as styrene, 2,4-dimethylstyrene, α-methylstyrene, p-ethylstyrene, O-methylstyrene, m-methylstyrene, p-methylstyrene, p-chlorostyrene and vinylnaphthalene; ethylenic monocarboxylic acids and its esters, such as 2-ethylhexyl acrylate, methyl methacrylate, acrylic acid, methyl acrylate, ethyl acrylate, n-propyl acrylate, isobutyl acrylate, t-butyl acrylate, amyl acrylate, cyclohexyl acrylate, n-octyl acrylate, isooctyl acrylate, decyl acrylate, lauryl acrylate, stearyl acrylate, methoxyethyl acrylate, 2-hydroxyethyl acrylate, glycidyl acrylate, phenyl acrylate, α-chloroacrylic acid methyl, methacrylic acid, ethyl methacrylate, n-propyl methacrylate, isopropyl methacrylate, n-butyl methacrylate, isobutyl methacrylate, t-butyl methacrylate, amyl methacrylate, cyclohexyl methacrylate, n-octyl methacrylate, isooctyl methacrylate, decyl methacrylate, lauryl methacrylate, 2-ethylhexyl methacrylate, stearyl methacrylate, methoxyethyl methacrylate, 2-Hydroxyethyl methacrylate, glycidyl methacrylate, phenyl methacrylate, dimethylaminoethyl methacrylate and diethylaminoethyl methacrylate; ethylenically unsaturated monoolefins, such as ethylene, propylene, butylene and isobutylene; vinyl esters, such as vinyl chloride, bromide-vinyl acetate, vinyl propionate, vinyl formate and vinyl caproate; substituted monomers of the ethylenic monocarboxylic acids, such as acrylonitrile, methacrylonitrile and acrylamide; ethylenic dicarboxylic acids and substituted monomers thereof such as maleic ester; vinyl ketones such as vinyl methyl ketone; and vinyl ethers such as vinyl methyl ether.

As the colorant, widely known pigments or dyes corresponding to colors of black, yellow, magenta and cyan can be used, no limitation thereto intended. Carbon black is suitable as a black colorant.

As the cross-linking agent in the emulsion polymerization method, general cross-linking agents can be used: divinylbenzene, divinylnaphtalene, polyethylene glycol dimethacrylate, 2,2′-bis (4-methacryloxy diethoxyphenyl) propane, 2,2′-bis (4-acryloxy diethoxyphenyl) propane, diethylene glycol diacrylate, triethylene glycol diacrylate, 3-butylene glycol dimethacrylate, 1,6-hexylene glycol dimethacrylate, neopentyl glycol dimethacrylate, dipropylene glycol dimethacrylate, polypropylene glycol dimethacrylate, trimethylolpropane trimethacrylate, trimethylolpropane triacrylate, tetramethylolmethane tetraacrylate and the like. Two or more of these agents can be used in combination, if necessary.

Examples of an inorganic powder added as the external additives are as follows: metal oxides, such as zinc, aluminum, cerium, cobalt, iron, zirconium, chrome, manganese, strontium, tin and antimony; complex metal oxides, such as calcium titanate, magnesium titanate and strontium titanate; metal salts, such as barium sulfate, calcium carbonate, magnesium carbonate and aluminum carbonate; clay minerals, such as kaolin; phosphate compounds, such as apatite; silicon compounds, such as silica, silicon carbide and silicon nitride; and carbon powders, such as carbon black and graphite.

### EXAMPLES

Next, various examples and comparative examples of the developer 7 will be explained. The examples are given solely for the purposes of illustration and are not to be construed as limitations of the present invention.

### (Manufacturing Process of Pulverized Toner)

In the examples and the comparative examples, a pulverized toner was manufactured by the following process: mixing by using a Henschel mixer 100 parts by weight of a binder resin (a polyester resin, a glass transition temperature Tg is 62° C. and a softening temperature T1/2 is 115° C.), 0.5 parts by weight of a charge control agent (T-77, manufactured by Hodogaya Chemical Co., Ltd.), 5.0 parts by weight of carbon black (MOGUL-L, manufactured by Cabot Corporation) as a colorant and 4.0 parts by weight of carnauba wax (Powdered Carnauba Wax No. 1, manufactured by S. Kato & Co.) as a release agent; melt blending the mixture by using a twin-screw extruder; cooling the mixture; crushing the cooled mixture by using a cutter mill which has a 2 mm diameter screen; pulverizing the crushed mixture by using an impact-type pulverizer ‘Dispersion Separator’ (manufactured by Nippon Pneumatic Mfg. Co., Ltd.); classifying by using an air classifier; and thus obtaining toner base particles (hereinafter referred to as “the first toner base particles”) having a mean volume diameter of 7.0 μm. The mean volume diameter of the first toner base particles was determined from a measurement by using a cell counter and analyzer ‘Coulter Multisizer 3’ (manufactured by Beckman Coulter, Inc.). In the measurement, an aperture diameter was 100 μm and the number of counts was 30000.

Circularity was measured by using a flow particle image analyzer ‘FPIA-2100’ manufactured by Sysmex Corporation, according to the following equation (1):

circularity=L1/L2, (1)

where L1 is a perimeter of a circle having the same area as that of a particle projected image, and L2 is a perimeter of the particle projected image. If a particle has a circularity of 1.00, the shape of the particle is perfectly spherical. When a circularity is less than 1.00, the less the circularity becomes, the particle shape becomes more indefinite. A mean circularity for ten first toner base particles was calculated, and the calculated value of 0.90 was yielded.

By mixing the first toner base particles and ‘Aerosil RX50’ (manufactured by Nippon Aerosil Co., Ltd.), a toner was obtained. As to the obtained toner, a triboelectric charge amount obtained by blow-off charge measurement (hereinafter simply referred to as ‘charge amount’) and a toner cohesion value were measured under each of the LL and HH environments. The blow-off charge measurement was made by using a blow-off charge measurement apparatus ‘TB-203’ (manufactured by KYOCERA Chemical Corporation).

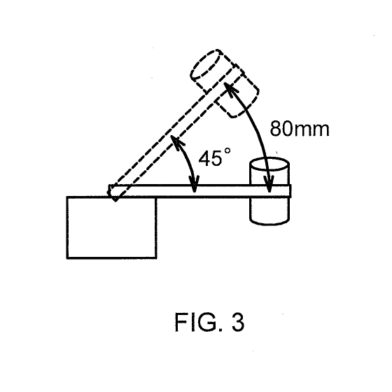

The triboelectric charge was measured by using ‘F-60’ (manufactured by Powder Tech Co., Ltd.) as a carrier. The toner and the carrier were mixed in a proportion of toner:carrier=1:19 and shaken for 10 minutes at a shaking frequency of 200 times per minute by using a shaker ‘model YS-LD’ manufactured by Yayoi Co., Ltd. A shake angle was 0° to 45° and a shake width was 80 mm, as illustrated in FIG. 3. A SUS-316 wire mesh of 400 MESH (a wire mesh designated for powder charge measurement by Kyocera) was used for the blow-off charge measurement apparatus. In the measurement for 10 seconds, blow pressure was 7 kPa and suction pressure was 4.5 kPa. Thus, an electric charge amount Q/M (unit: μC/g) of the toner particle per unit weight was calculated from an electric charge amount and a suction amount obtained after 10 seconds.

A toner cohesion value was measured by using a Multi Tester MT-1001 manufactured by Seishin Enterprise Co., Ltd. The measurement was made as follows: first, placing a 250 μm mesh sieve, a 150 μm mesh sieve and a 75 μm mesh sieve in layer on a shake table, the 250 μm mesh sieve on top of the others; next, placing 2 g of a sample on the top 250 μm mesh sieve; and then, shaking these mesh sieves for 95 seconds at an amplitude of 1 mm. After the shaking, the toner cohesion value Cv was calculated according to the following equation (2):

Cv=(5×W₁+3×W₂+W₃)×20/Wa, (2)

where W₁ represents a weight of the sample remained on the 250 μm mesh sieve after the shaking (unit: g); W₂ represents a weight of the sample remained on the 150 μm mesh sieve after the shaking (unit: g); W₃ represents a weight of the sample remained on the 75 μm mesh sieve after the shaking (unit: g); and Wa represents the whole weight of the sample, i.e., 2 g.

### Comparative Example 1-1

Toner A-1 was obtained by adding 1.0 part by weight of ‘Aerosil RX50’ (manufactured by Nippon Aerosil Co., Ltd.) to 100 parts by weight of the first toner base particles of circularity 0.90 and mixing them for 25 minutes. Under the LL environment, a charge amount was 18 μC/g and a toner cohesion value was 52. Under the HH environment, a charge amount was 18 μC/g and a toner cohesion value was 70.

### Comparative Example 1-2

Toner A-2 was obtained by adding 1.1 parts by weight of ‘Aerosil RX50’ (manufactured by Nippon Aerosil Co., Ltd.) to 100 parts by weight of the first toner base particles of circularity 0.90 and mixing them for 25 minutes. Under the LL environment, a charge amount was 18 μC/g and a toner cohesion value was 51. Under the HH environment, a charge amount was 17 μC/g and a toner cohesion value was 71.

### Example 1-1

Toner A-3 was obtained by adding 1.2 parts by weight of ‘Aerosil RX50’ (manufactured by Nippon Aerosil Co., Ltd.) to 100 parts by weight of the first toner base particles of circularity 0.90 and mixing them for 25 minutes. Under the LL environment, a charge amount was 19 μC/g and a toner cohesion value was 50. Under the HH environment, a charge amount was 18 μC/g and a toner cohesion value was 70.

### Example 1-2

Toner A-4 was obtained by adding 1.3 parts by weight of ‘Aerosil RX50’ (manufactured by Nippon Aerosil Co., Ltd.) to 100 parts by weight of the first toner base particles of circularity 0.90 and mixing them for 25 minutes. Under the LL environment, a charge amount was 20 μC/g and a toner cohesion value was 30. Under the HH environment, a charge amount was 19 μC/g and a toner cohesion value was 50.

### Example 1-3

Toner A-5 was obtained by adding 1.4 parts by weight of ‘Aerosil RX50’ (manufactured by Nippon Aerosil Co., Ltd.) to 100 parts by weight of the first toner base particles of circularity 0.90 and mixing them for 25 minutes. Under the LL environment, a charge amount was 18 μC/g and a toner cohesion value was 10. Under the HH environment, a charge amount was 17 μC/g and a toner cohesion value was 30.

### Comparative Example 1-3

Toner A-6 was obtained by adding 1.5 parts by weight of ‘Aerosil RX50’ (manufactured by Nippon Aerosil Co., Ltd.) to 100 parts by weight of the first toner base particles of circularity 0.90 and mixing them for 25 minutes. Under the LL environment, a charge amount was 19 μC/g and a toner cohesion value was 9. Under the HH environment, a charge amount was 18 μC/g and a toner cohesion value was 29.

### Comparative Example 1-4

Toner A-7 was obtained by adding 1.5 parts by weight of ‘Aerosil RX50’ (manufactured by Nippon Aerosil Co., Ltd.) and 0.1 parts by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 29 μC/g and a toner cohesion value was 51. Under the HH environment, a charge amount was 19 μC/g and a toner cohesion value was 71.

### Example 1-4

Toner A-8 was obtained by adding 1.5 parts by weight of ‘Aerosil RX50’ (manufactured by Nippon Aerosil Co., Ltd.) and 0.2 parts by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 30 μC/g and a toner cohesion value was 50. Under the HH environment, a charge amount was 19 μC/g and a toner cohesion value was 70.

### Example 1-5

Toner A-9 was obtained by adding 1.5 parts by weight of ‘Aerosil RX50’ (manufactured by Nippon Aerosil Co., Ltd.) and 0.3 parts by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 29 μC/g and a toner cohesion value was 30. Under the HH environment, a charge amount was 18 μC/g and a toner cohesion value was 50.

### Example 1-6

Toner A-10 was obtained by adding 1.5 parts by weight of ‘Aerosil RX50’ (manufactured by Nippon Aerosil Co., Ltd.) and 0.4 parts by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 28 μC/g and a toner cohesion value was 10. Under the HH environment, a charge amount was 17 μC/g and a toner cohesion value was 30.

### Comparative Example 1-5

Toner A-11 was obtained by adding 1.5 parts by weight of ‘Aerosil RX50’ (manufactured by Nippon Aerosil Co., Ltd.) and 0.5 parts by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 30 μC/g and a toner cohesion value was 9. Under the HH environment, a charge amount was 19 μC/g and a toner cohesion value was 29.

### Comparative Example 1-6

Toner A-12 was obtained by adding 1.5 parts by weight of ‘Aerosil RX50’ (manufactured by Nippon Aerosil Co., Ltd.) and 0.8 parts by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 28 μC/g and a toner cohesion value was 51. Under the HH environment, a charge amount was 8 μC/g and a toner cohesion value was 71.

### Example 1-7

Toner A-13 was obtained by adding 1.5 parts by weight of ‘Aerosil RX50’ (manufactured by Nippon Aerosil Co., Ltd.) and 0.9 parts by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 27 μC/g and a toner cohesion value was 50. Under the HH environment, a charge amount was 7 μC/g and a toner cohesion value was 70.

### Example 1-8

Toner A-14 was obtained by adding 1.5 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 29 μC/g and a toner cohesion value was 30. Under the HH environment, a charge amount was 9 μC/g and a toner cohesion value was 50.

### Example 1-9

Toner A-15 was obtained by adding 1.6 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 28 μC/g and a toner cohesion value was 10. Under the HH environment, a charge amount was 8 μC/g and a toner cohesion value was 30.

### Comparative Example 1-7

Toner A-16 was obtained by adding 1.7 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 29 μC/g and a toner cohesion value was 9. Under the HH environment, a charge amount was 9 μC/g and a toner cohesion value was 29.

### Comparative Example 1-8

Toner A-17 was obtained by adding 2.0 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 35 μC/g and a toner cohesion value was 51. Under the HH environment, a charge amount was 14 μC/g and a toner cohesion value was 71.

### Comparative Example 1-9

Toner A-18 was obtained by adding 2.1 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 32 μC/g and a toner cohesion value was 50. Under the HH environment, a charge amount was 11 μC/g and a toner cohesion value was 70.

### Comparative Example 1-10

Toner A-19 was obtained by adding 2.2 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 33 μC/g and a toner cohesion value was 30. Under the HH environment, a charge amount was 12 μC/g and a toner cohesion value was 50.

### Comparative Example 1-11

Toner A-20 was obtained by adding 2.3 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 32 μC/g and a toner cohesion value was 10. Under the HH environment, a charge amount was 11 μC/g and a toner cohesion value was 30.

### Comparative Example 1-12

Toner A-21 was obtained by adding 2.4 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the first toner base particles of circularity 0.90 and mixing them for 25 minutes. Under the LL environment, a charge amount was 35 μC/g and a toner cohesion value was 9. Under the HH environment, a charge amount was 14 μC/g and a toner cohesion value was 29.

### (Evaluation of Pulverized Toner)

The pulverized toner was used in the image forming apparatus 100 in FIG. 1. A 1.25% duty image (a belt-shaped image with a 1.25% black-colored area, where a 100% duty image is an image with a 100% black colored area) was printed on a paper sheet of standard letter size (e.g., paper of Xerox 4200; 92 brightness; and 20 Lb basis weight) fed in a vertical direction (the two shorter sides out of the four sides of the sheet being a top end and a bottom end), a white paper sheet was printed every 1K sheets printing and then another white paper sheet was printed, the printing of the another white paper sheet was halfway stopped for a moment by turning off, and fogs on the photosensitive drum were obtained in the following manner: detaching the photosensitive drum from the image forming apparatus 100, attaching a transparent mending tape detachably to the photosensitive drum for removing the toner stuck to the photosensitive drum, attaching the detached tape to a white paper sheet. So, another piece of the mending tape was attached to the white paper sheet in advance. An average of color differences ΔE (for similar five points) on the detached mending tape was measured by using a spectrophotometer ‘CM-2600d’ manufactured by Konica Minolta (measurement aperture φ810 mm), after the mending tape was detached from the photosensitive drum.

A color difference ΔE is given by the following equation (3):

ΔE=[(L₁−L₂)²+(a₁−a₂)²+(b₁−b₂)²]^{1/2}, (3)

where L₁, a₁ and b₁ represent lightness (L₁) and chromaticities (a₁, b₁) of the mending tape after the printing of white paper sheet was stopped for a moment and the detachment from the photosensitive drum, respectively; and L₂, a₂ and b₂ represent lightness (L₂) and chromaticities (a₂, b₂) of the mending tape itself, respectively.

A color difference ΔE is a value representing a degree of fog on the photosensitive drum. A value of the color difference ΔE is hereinafter referred to as a fog value. The image quality for the fog was determined as follows:

o (good): a fog value ΔE of 1.5 or less

x (poor): a fog value ΔE of 1.6 or more

The image quality for the smudge was determined as follows:

o (good): nothing is printed in a non-printing area

x (poor): the toner is printed in a non-printing area where smudge exists

A consecutive printing test in which a 1.25%-duty image was printed on every sheet was performed on 5K sheets (i.e., 5000 sheets), if no problem arose, under the LL and HH environment.

In a case of the toner A-1 of the comparative example 1-1, smudge was observed in a left edge portion after 2K sheets were printed under the LL environment.

In a case of the toner A-2 of the comparative example 1-2, smudge was observed in a left edge portion after 3K sheets were printed under the LL environment.

In a case of the toner A-3 of the example 1-1, no smudge was observed and a fog value ΔE was 1.5 or less until 5K-sheet printing ended under both of the LL and HH environments.

In a case of the toner A-4 of the example 1-2, no smudge was observed and a fog value ΔE was 1.5 or less until 5K-sheet printing ended under both of the LL and HH environments.

In a case of the toner A-5 of the example 1-3, no smudge was observed and a fog value ΔE was 1.5 or less until 5K-sheet printing ended under both of the LL and HH environments.

In a case of the toner A-6 of the comparative example 1-3, no smudge was observed and a fog value ΔE was equal to 3.5 after 3K sheets were printed under the HH environment.

In a case of the toner A-7 of the comparative example 1-4, smudge was observed in a left edge portion after 4K sheets were printed under the LL environment.

In a case of the toner A-8 of the example 1-4, no smudge was observed and a fog value ΔE was 1.5 or less until 5K-sheet printing ended under both of the LL and HH environments.

In a case of the toner A-9 of the example 1-5, no smudge was observed and a fog value was 1.5 or less until 5K-sheet printing ended under both of the LL and HH environments.

In a case of the toner A-10 of the example 1-6, no smudge was observed and a fog value ΔE was 1.5 or less until 5K-sheet printing ended under both of the LL and HH environments.

In a case of the toner A-11 of the comparative example 1-5, no smudge was observed and a fog value ΔE was equal to 3.8 after 4K sheets were printed under the HH environment.

In a case of the toner A-12 of the comparative example 1-6, smudge was observed in a left edge portion after 2K sheets were printed under the LL environment.

In a case of the toner A-13 of the example 1-7, no smudge was observed and a fog value ΔE was 1.5 or less until 5K-sheet printing ended under both of the LL and HH environments.

In a case of the toner A-14 of the example 1-8, no smudge was observed and a fog value ΔE was 1.5 or less until 5K-sheet printing ended under both of the LL and HH environments.

In a case of the toner A-15 of the example 1-9, no smudge was observed and a fog value ΔE was 1.5 or less until 5K-sheet printing ended under both of the LL and HH environments.

In a case of the toner A-16 of the comparative example 1-7, no smudge was observed and a fog value ΔE was equal to 2.7 after 3K sheets were printed under the HH environment.

In a case of the toner A-17 of the comparative example 1-8, smudge was observed in a left edge portion after 4K sheets were printed under the LL environment.

In a case of the toner A-18 of the comparative example 1-9, smudge was observed in a left edge portion after 3K sheets were printed under the LL environment.

In a case of the toner A-19 of the comparative example 1-10, no smudge was observed and a fog value ΔE was equal to 3.1 after 5K-sheet were printed under the HH environment.

In a case of the toner A-20 of the comparative example 1-11, no smudge was observed and a fog value ΔE was equal to 4.1 after 3K sheets were printed under the HH environment.

In a case of the toner A-21 of the comparative example 1-12, no smudge was observed and a fog value ΔE was equal to 3.6 after 2K sheets were printed under the HH environment.

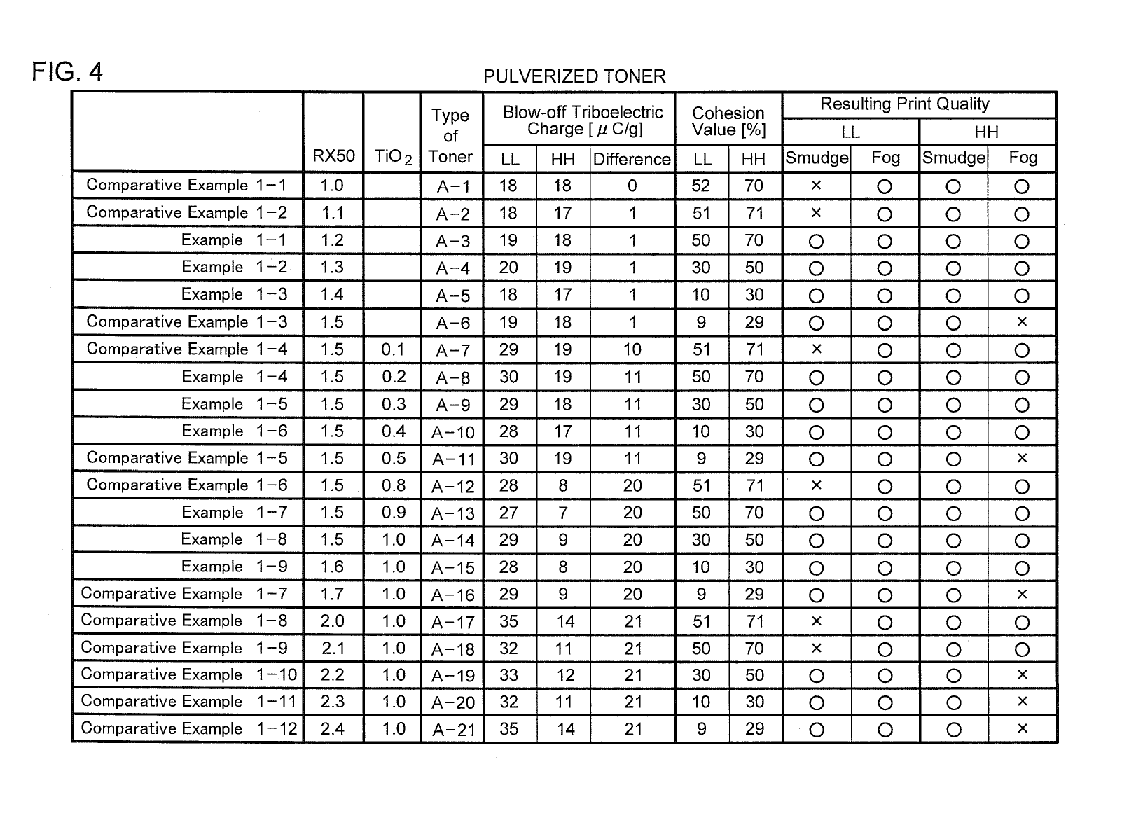

FIG. 4 illustrates a table in which measurement results and corresponding evaluations are listed with respect to the pulverized toners. As described above, in the case of the pulverized toner, it was found that good printing without smudge and fog could be achieved under the LL and HH environments, when a difference (absolute value) between triboelectric charge amounts under the LL and HH environments obtained by blow-off charge measurement was equal to or less than 20 μC/g, a toner cohesion value under the LL environment was within the range of 10% to 50%, and a toner cohesion value under the HH environment was within the range of 30% to 70%.

### (Manufacturing Process of Polymerized Toner)

As the developer 7, a polymerized toner is obtained by mixing a styrene-acrylic copolymer resin produced by an emulsion polymerization method, a colorant and a wax; obtaining toner base particles (hereinafter referred to as “the second toner base particles”) as a result of cohesion of the mixture; and mixing the toner particles and fine powders of silica and titanium oxide by using a mixer.

The emulsion polymerization method is a method to obtain toner particles by producing in a liquid solvent primary particles of a polymer as a toner binder resin; mixing a colorant emulsified by an emulsifier (surface active agent) into the solvent in which the primary particles are dissolved; mixing a wax, a charge control agent and the like, if necessary; producing toner particles by cohering the mixture in the solvent; extracting the toner particles from the solvent; and removing unnecessary solvent component and by-product component by means of cleaning and drying. In this example, a styrene-acrylic copolymer resin was produced from styrene, acrylic acid and methyl methacrylate. A carbon black was used as the black colorant and stearyl stearate as a higher fatty acid ester wax was used as the wax. The toner thus obtained has a mean particle diameter of 7.0 μm before addition of external additives. The mean particle diameter of the obtained toner before addition of external additives was determined from a measurement by using a cell counter and analyzer ‘Coulter Multisizer 3’ (manufactured by Beckman Coulter, Inc.). In the measurement, an aperture diameter was 100 μm and the number of counts was 30000.

Circularity was measured according to the equation (1) by using the flow particle image analyzer ‘FPIA-2100’manufactured by Sysmex Corporation, as well as the case of the pulverized toner. A mean circularity for ten second toner base particles was calculated, and the calculated value of 0.97 was yielded.

### Comparative Example 2-1

Toner B-1 was obtained by adding 1.0 part by weight of ‘Aerosil RX50’ (manufactured by Nippon Aerosil Co., Ltd.) to 100 parts by weight of the second toner base particles having a mean circularity of 0.97, and mixing them for 25 minutes. Under the LL environment, a charge amount was 17 μC/g and a toner cohesion value was 51. Under the HH environment, a charge amount was 17 μC/g and a toner cohesion value was 71.

### Comparative Example 2-2

Toner B-2 was obtained by adding 1.1 parts by weight of ‘Aerosil RX50’ (manufactured by Nippon Aerosil Co., Ltd.) to 100 parts by weight of the second toner base particles having a mean circularity of 0.97, and mixing them for 25 minutes. Under the LL environment, a charge amount was 19 μC/g and a toner cohesion value was 51. Under the HH environment, a charge amount was 18 μC/g and a toner cohesion value was 71.

### Example 2-1

Toner B-3 was obtained by adding 1.2 parts by weight of ‘Aerosil RX50’ (manufactured by Nippon Aerosil Co., Ltd.) to 100 parts by weight of the second toner base particles having a mean circularity of 0.97, and mixing them for 25 minutes. Under the LL environment, a charge amount was 20 μC/g and a toner cohesion value was 50. Under the HH environment, a charge amount was 19 μC/g and a toner cohesion value was 70.

### Example 2-2

Toner B-4 was obtained by adding 1.3 parts by weight of ‘Aerosil RX50’ (manufactured by Nippon Aerosil Co., Ltd.) to 100 parts by weight of the second toner base particles having a mean circularity of 0.97, and mixing them for 25 minutes. Under the LL environment, a charge amount was 21 μC/g and a toner cohesion value was 30. Under the HH environment, a charge amount was 20 μC/g and a toner cohesion value was 50.

### Example 2-3

Toner B-5 was obtained by adding 1.4 parts by weight of ‘Aerosil RX50’ (manufactured by Nippon Aerosil Co., Ltd.) to 100 parts by weight of the second toner base particles having a mean circularity of 0.97, and mixing them for 25 minutes. Under the LL environment, a charge amount was 22 μC/g and a toner cohesion value was 10. Under the HH environment, a charge amount was 23 μC/g and a toner cohesion value was 30.

### Comparative Example 2-3

Toner B-6 was obtained by adding 1.5 parts by weight of ‘Aerosil RX50’ (manufactured by Nippon Aerosil Co., Ltd.) to 100 parts by weight of the second toner base particles having a mean circularity of 0.97, and mixing them for 25 minutes. Under the LL environment, a charge amount was 23 μC/g and a toner cohesion value was 9. Under the HH environment, a charge amount was 22 μC/g and a toner cohesion value was 29.

### Comparative Example 2-4

Toner B-7 was obtained by adding 1.5 parts by weight of ‘Aerosil RX50’ (manufactured by Nippon Aerosil Co., Ltd.) and 0.1 parts by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 30 μC/g and a toner cohesion value was 51. Under the HH environment, a charge amount was 19 μC/g and a toner cohesion value was 71.

### Example 2-4

Toner B-8 was obtained by adding 1.5 parts by weight of ‘Aerosil RX50’ (manufactured by Nippon Aerosil Co., Ltd.) and 0.2 parts by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 31 μC/g and a toner cohesion value was 19. Under the HH environment, a charge amount was 19 μC/g and a toner cohesion value was 70.

### Example 2-5

Toner B-9 was obtained by adding 1.5 parts by weight of ‘Aerosil RX50’ (manufactured by Nippon Aerosil Co., Ltd.) and 0.3 parts by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 33 μC/g and a toner cohesion value was 30. Under the HH environment, a charge amount was 18 μC/g and a toner cohesion value was 50.

### Example 2-6

Toner B-10 was obtained by adding 1.5 parts by weight of ‘Aerosil RX50’ (manufactured by Nippon Aerosil Co., Ltd.) and 0.4 parts by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 32 μC/g and a toner cohesion value was 10. Under the HH environment, a charge amount was 17 μC/g and a toner cohesion value was 30.

### Comparative Example 2-5

Toner B-11 was obtained by adding 1.5 parts by weight of ‘Aerosil RX50’ (manufactured by Nippon Aerosil Co., Ltd.) and 0.5 parts by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 34 μC/g and a toner cohesion value was 9. Under the HH environment, a charge amount was 19 μC/g and a toner cohesion value was 29.

### Comparative Example 2-6

Toner B-12 was obtained by adding 1.5 parts by weight of ‘Aerosil RX50’ (manufactured by Nippon Aerosil Co., Ltd.) and 0.8 parts by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 33 μC/g and a toner cohesion value was 51. Under the HH environment, a charge amount was 13 μC/g and a toner cohesion value was 71.

### Example 2-7

Toner B-13 was obtained by adding 1.5 parts by weight of ‘Aerosil RX50’ (manufactured by Nippon Aerosil Co., Ltd.) and 0.9 parts by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 34 μC/g and a toner cohesion value was 50. Under the HH environment, a charge amount was 14 μC/g and a toner cohesion value was 70.

### Example 2-8

Toner B-14 was obtained by adding 1.5 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 35 μC/g and a toner cohesion value was 30. Under the HH environment, a charge amount was 15 μC/g and a toner cohesion value was 50.

### Example 2-9

Toner B-15 was obtained by adding 1.6 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 36 μC/g and a toner cohesion value was 10. Under the HH environment, a charge amount was 16 μC/g and a toner cohesion value was 30.

### Comparative Example 2-7

Toner B-16 was obtained by adding 1.7 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 29 μC/g and a toner cohesion value was 9. Under the HH environment, a charge amount was 9 μC/g and a toner cohesion value was 29.

### Comparative Example 2-8

Toner B-17 was obtained by adding 2.0 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 35 μC/g and a toner cohesion value was 51. Under the HH environment, a charge amount was 14 μC/g and a toner cohesion value was 71.

### Comparative Example 2-9

Toner B-18 was obtained by adding 2.1 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 32 μC/g and a toner cohesion value was 50. Under the HH environment, a charge amount was 11 μC/g and a toner cohesion value was 70.

### Comparative Example 2-10

Toner B-19 was obtained by adding 2.2 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 33 μC/g and a toner cohesion value was 30. Under the HH environment, a charge amount was 12 μC/g and a toner cohesion value was 50.

### Comparative Example 2-11

Toner B-20 was obtained by adding 2.3 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 32 μC/g and a toner cohesion value was 10. Under the HH environment, a charge amount was 11 μC/g and a toner cohesion value was 30.

### Comparative Example 2-12

Toner B-21 was obtained by adding 2.4 parts by weight of ‘Aerosil RX50’ (manufactured by Nippon Aerosil Co., Ltd.) and 1.0 part by weight of titanium oxide (manufactured by Fuji Titanium Industry Co., Ltd., a particle diameter of 200 nm) to 100 parts by weight of the second toner base particles having a mean circularity of 0.97, and mixing them for 25 minutes. Under the LL environment, a charge amount was 35 μC/g and a toner cohesion value was 9. Under the HH environment, a charge amount was 14 μC/g and a toner cohesion value was 29.

### (Evaluation of Polymerized Toner)

The polymerized toner was used in the image forming apparatus 100 in FIG. 1. Experiments were similar to those in the examples of the pulverized toner described above.

In a case of the toner B-1 of the comparative example 2-1, smudge was observed in a left edge portion after 3K sheets were printed under the LL environment.

In a case of the toner B-2 of the comparative example 2-2, smudge was observed in a left edge portion after 4K sheets were printed under the LL environment.

In a case of the toner B-3 of the example 2-1, no smudge was observed and a fog value ΔE was 1.5 or less until 5K-sheet printing ended under both of the LL and HH environments.

In a case of the toner B-4 of the example 2-2, no smudge was observed and a fog value ΔE was 1.5 or less until 5K-sheet printing ended under both of the LL and HH environments.

In a case of the toner B-5 of the example 2-3, no smudge was observed and a fog value ΔE was 1.5 or less until 5K-sheet printing ended under both of the LL and HH environments.

In a case of the toner B-6 of the comparative example 2-3, no smudge was observed and a fog value ΔE was equal to 4.2 after 3K sheets were printed under the HH environment.

In a case of the toner B-7 of the comparative example 2-4, smudge was observed in a left edge portion after 4K sheets were printed under the LL environment.

In a case of the toner B-8 of the example 2-4, no smudge was observed and a fog value ΔE was 1.5 or less until 5K-sheet printing ended under both of the LL and HH environments.

In a case of the toner B-9 of the example 2-5, no smudge was observed and a fog value ΔE was 1.5 or less until 5K-sheet printing ended under both of the LL and HH environments.

In a case of the toner B-10 of the example 2-6, no smudge was observed and a fog value ΔE was 1.5 or less until 5K-sheet printing ended under both of the LL and HH environments.

In a case of the toner B-11 of the comparative example 2-5, no smudge was observed and a fog value ΔE was equal to 3.7 after 2K sheets were printed under the HH environment.

In a case of the toner B-12 of the comparative example 2-6, smudge was observed in a left edge portion after 4K sheets were printed under the LL environment.

In a case of the toner B-13 of the example 2-7, no smudge was observed and a fog value ΔE was 1.5 or less until 5K-sheet printing ended under both of the LL and HH environments.

In a case of the toner B-14 of the example 2-8, no smudge was observed and a fog value ΔE was 1.5 or less until 5K-sheet printing ended under both of the LL and HH environments.

In a case of the toner B-15 of the example 2-9, no smudge was observed and a fog value ΔE was 1.5 or less until 5K-sheet printing ended under both of the LL and HH environments.

In a case of the toner B-16 of the comparative example 2-7, no smudge was observed and a fog value ΔE was equal to 2.9 after 5K sheets were printed under the HH environment.

In a case of the toner B-17 of the comparative example 2-8, smudge was observed in a left edge part after 3K sheets were printed under the LL environment.

In a case of the toner B-18 of the comparative example 2-9, smudge was observed in a left edge portion after 4K sheets were printed under the LL environment.

In a case of the toner B-19 of the comparative example 2-10, no smudge was observed and a fog value ΔE was equal to 2.6 after 4K sheets were printed under the HH environment.

In a case of the toner B-20 of the comparative example 2-11, no smudge was observed and a fog value ΔE was equal to 3.4 after 3K sheets were printed under the HH environment.

In a case of the toner B-21 of the comparative example 2-12, no smudge was observed and a fog value ΔE was equal to 3.5 after 2K sheets were printed under the HH environment.

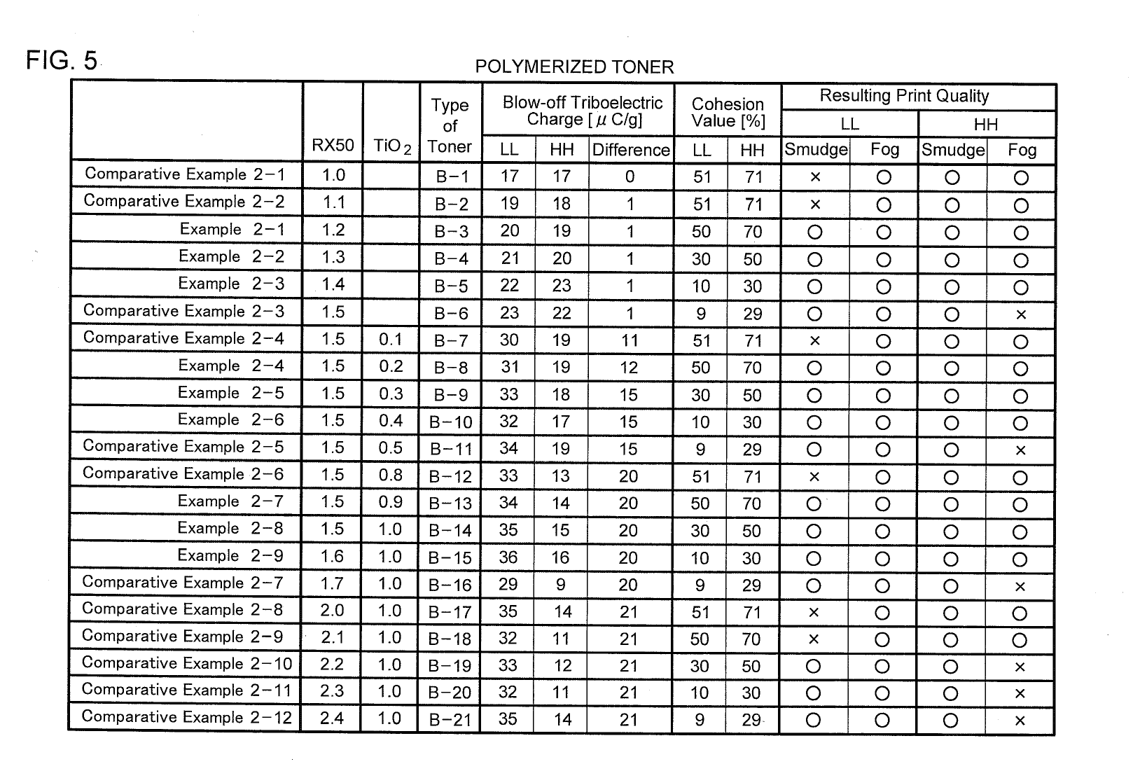

FIG. 5 illustrates a table in which measurement results and corresponding evaluations are listed with respect to the polymerized toners. As described above, in the case of the emulsion polymerized toner, it was found that good printing without smudge and fog could be achieved under the LL and HH environments, when a difference (absolute value) between triboelectric charge amounts under the LL and HH environments obtained by blow-off charge measurement was equal to or less than 20 μC/g, a toner cohesion value under the LL environment was within the range of 10% to 50%, and a toner cohesion value under the HH environment was within the range of 30% to 70%.

In the foregoing specification, the invention has been described with reference to specific embodiments thereof. It will, however, be evident that various modifications and changes can be made to the specific embodiments without departing from the broader spirit and scope of the invention as set forth in the appended claims. For example, it is possible to achieve the same effects as the embodiments when developer manufacturing processes other than the above-described manufacturing processes of the developer 7 are used.

As described above, the electrophotographic image forming apparatus 100 includes an electrophotographic system using single-component development. Nonetheless, dual-component development can be used instead of the single-component development. Moreover, the above electrophotographic system can be applied to photocopiers or facsimile machines.

What is claimed is:

1. A developer comprising at least a toner for developing electrostatic latent images, the toner including:
toner base particles each containing at least one binder resin; and
external additives for adhering to outer surfaces of the toner base particles,
wherein the toner has: a first triboelectric charge obtained by blow-off charge measurement at 20% relative humidity and a temperature of 10° C.; and a second triboelectric charge obtained by blow-off charge measurement at 80% relative humidity and a temperature of 28° C., an absolute value of a difference between the first and second triboelectric charges being no larger than 20 μC/g.

2. The developer as claimed in claim 1, wherein the toner further has a first toner cohesion value measured at 20% relative humidity and a temperature of 10° C., the first toner cohesion value being in a range from 10 to 50 percent.

3. The developer as claimed in claim 1, wherein the toner further has a second toner cohesion value measured at 80% relative humidity and a temperature of 28° C., the first toner cohesion value being in a range from 30 to 70 percent.

4. The developer as claimed in claim 1, wherein the binder resin includes a polyester resin.

5. The developer as claimed in claim 4, wherein the toner is made by a mechanical grinding method.

6. The developer as claimed in claim 1, wherein the binder resin includes a styrene-acrylic copolymer resin.

7. The developer as claimed in claim 6, wherein the toner is made by an emulsion polymerization method.

8. The developer as claimed in claim 1, wherein the toner base particles are negatively charged.

9. The developer as claimed in claim 1, wherein each of the toner base particles contains at least one colorant.

10. The developer as claimed in claim 1, wherein the developer is a single-component developer.

11. A developer container containing the developer as claimed in claim 1.

12. An image forming unit, comprising:
the developer container as claimed in claim 11;
an image carrying member on which an electrostatic latent image is formed; and
a developer carrying member, having the developer provided by the developer container thereon, for bringing the developer into the electrostatic latent image thereby to form a developer image.

13. An image forming apparatus comprising the image forming unit as claimed in claim 12.
